(19) United States
(12) Patent Application Publication
(10) Pub. No.: US 2025/0217714 A1
(43) Pub. Date: Jul. 3, 2025

(54) UNIVERSALITY DETECTION FOR CONTINUAL LEARNING MODEL

(71) Applicant: Tencent Technology (Shenzhen) Company Limited, Shenzhen (CN)

(72) Inventors: Yun LUO, Shenzhen (CN); Zhen YANG, Shenzhen (CN); Fandong MENG, Shenzhen (CN)

(73) Assignee: Tencent Technology (Shenzhen) Company Limited, Shenzhen (CN)

(21) Appl. No.: 19/085,975

(22) Filed: Mar. 20, 2025

Related U.S. Application Data
(63) Continuation of application No. PCT/CN2024/070071, filed on Jan. 2, 2024.

(30) Foreign Application Priority Data
Mar. 2, 2023 (CN) 202310255313.0

(51) Int. Cl. G06N 20/00

(52) U.S. Cl. CPC G06N 20/00

(57) ABSTRACT

A method of universality detection includes performing respective classification task test processing on a continual learning language model and a single-task language model by using a first task set associated with a first classification task, to obtain a first classification accuracy of the continual learning language model and a second classification accuracy of the single-task language model. The method also includes performing a first test processing on a first text universal representation of the continual learning language model, to obtain a first test result associated with the continual learning language model; performing a second test processing on a second text universal representation of the initial pre-trained language model, to obtain a second test result associated with the initial pre-trained language model; and determining a final universal detection result according to the first classification accuracy, the second classification accuracy, the first test result and the second test result.

### RELATED APPLICATIONS

The present application is a continuation of International Application No. PCT/CN2024/070071, filed on Jan. 2, 2024, which claims priority to Chinese Patent Application No. 202310255313.0, filed on Mar. 2, 2023. The entire disclosures of the prior applications are hereby incorporated by reference.

### FIELD OF THE TECHNOLOGY

The present disclosure relates to the field of computer technologies, including a universality detection technology for a continual learning model.

### BACKGROUND OF THE DISCLOSURE

Currently, detection of a continual learning model is mainly to detect the effect of tasks that have been learned by the continual learning model. It ignores the growth potential of large-scale language models in a continual learning scenario and the storage of universal knowledge, and cannot explain changes in a language universal representation of the continual learning model during continual learning, which restricts the exploration and improvement of the continual learning scenario.

### SUMMARY

In view of the foregoing technical problem, this disclosure provides a universality detection method and apparatus for a continual learning model, and an electronic device.

Some aspects of the disclosure provide a method of universality detection for a continual learning model. In some examples, the method includes performing respective classification task test processing on a continual learning language model and a single-task language model by using a first task set associated with a first classification task, to obtain a first classification accuracy of the continual learning language model and a second classification accuracy of the single-task language model. The continual learning language model is obtained after an initial pre-trained language model continually learns one or more classification tasks until a completion of the first classification task; the single-task language model is obtained after the initial pre-trained language model learns the first classification task alone. The method also includes performing a first test processing on a first text universal representation of the continual learning language model by using a probe task set, to obtain a first test result associated with the continual learning language model; performing a second test processing on a second text universal representation of the initial pre-trained language model by using the probe task set, to obtain a second test result associated with the initial pre-trained language model; and determining a final universal detection result according to a classification accuracy difference between the first classification accuracy and the second classification accuracy, and a test result difference between the first test result and the second test result. The final universal detection result indicates an association relationship between a universal representation capability of the continual learning language model and a universal representation capability of a non-continual learning model, the non-continual learning model includes the initial pre-trained language model and the single-task language model.

According to another aspect of this disclosure, a universality detection apparatus for a continual learning model is provided. The apparatus is deployed on an electronic device, and the apparatus includes processing circuitry configured to perform respective classification task test processing on a continual learning language model and a single-task language model by using a first task set associated with a first classification task, to obtain a first classification accuracy of the continual learning language model and a second classification accuracy of the single-task language model. The continual learning language model is obtained after an initial pre-trained language model continually learns one or more classification tasks until a completion of the first classification task. The single-task language model is obtained after the initial pre-trained language model learns the first classification task alone. The processing circuitry is also configured to perform a first test processing on a first text universal representation of the continual learning language model by using a probe task set, to obtain a first test result associated with the continual learning language model; perform a second test processing on a second text universal representation of the initial pre-trained language model by using the probe task set, to obtain a second test result associated with the initial pre-trained language model; and determine a final universal detection result according to a classification accuracy difference between the first classification accuracy and the second classification accuracy, and a test result difference between the first test result and the second test result. The final universal detection result indicates an association relationship between a universal representation capability of the continual learning language model and a universal representation capability of a non-continual learning model, the non-continual learning model includes the initial pre-trained language model and the single-task language model.

According to another aspect of this disclosure, an electronic device is provided. The electronic device includes: a processor; and a memory, configured to store executable instructions of the processor, the processor being configured to execute the executable instructions to implement the foregoing method.

According to another aspect of this disclosure, a non-volatile computer-readable storage medium (e.g., non-transitory computer readable storage medium) is provided. The non-volatile computer-readable storage medium has computer program instructions stored therein, the computer program instructions, when executed by a processor, implementing the foregoing method.

According to another aspect of this disclosure, a computer program product is provided. The computer program product includes computer instructions, the computer instructions, when executed by a processor, causing an electronic device to implement the foregoing method.

By respectively performing classification task test processing on a continual learning language model and a single-task language model by using a task set to be tested corresponding to a task to be classified (also referred to as a classification task), a classification accuracy difference between the continual learning language model and the single-task language model is obtained, and by respectively performing test processing on text universal representations of the continual learning language model and an initial pre-trained language model by using a probe task set, a difference between the continual learning language model and the initial pre-trained language model in a text universal representation capability is obtained. Therefore, a final universal detection result of the continual learning language model that continually learns to the task to be classified may be determined based on the two differences, so that the final universal detection result not only can represent changes in a classification task universal representation between continual learning and non-continual learning, but also can represent changes in the text universal representation between the continual learning language model and the initial pre-trained language model, making the final universal detection result more precise, and explaining changes in the universality of the continual learning model more accurately and effectively. Based on this, by using the final universal detection result, in a case that a single model is used to implement a plurality of classification functions, a text universal representation capability of the single model can be effectively and flexibly controlled, so that not only the diversity of applications of the single model can be increased, to avoid training a model for each classification task, but also the requirement of the plurality of classification tasks of the continual learning model for the text universal representation can be satisfied, and the classification accuracy of the continual learning model on the plurality of classification tasks can be improved.

Other features and aspects of this disclosure become apparent from the following detailed description of exemplary embodiments with reference to the accompanying drawings.

### BRIEF DESCRIPTION OF THE DRAWINGS

The accompanying drawings that are included in the specification and form a part of the specification illustrate, together with the specification, exemplary embodiments, features, and aspects of this disclosure, and used to explain the principles of this disclosure.

FIG. 1 is a schematic diagram of an application system according to an embodiment of this disclosure.

FIG. 2 is a flowchart of a universality detection method for a continual learning model according to an embodiment of this disclosure.

FIG. 3 is a schematic diagram of a process framework of classification task test processing according to an embodiment of this disclosure.

FIG. 4 is a schematic flowchart of respectively performing test processing on text universal representations of a continual learning language model and an initial pre-trained language model by using a probe task set, to obtain a first test result corresponding to the continual learning language model and a second test result corresponding to the initial pre-trained language model according to an embodiment of this disclosure.

FIG. 5 is a schematic flowchart of a syntactic representation test according to an embodiment of this disclosure.

FIG. 6 is a schematic flowchart of a semantic representation test according to an embodiment of this disclosure.

FIG. 7 is a schematic flowchart of universality detection of a continual learning model according to an embodiment of this disclosure.

FIG. 8 is a schematic diagram of classification accuracy and a final universal detection result in continual learning according to an embodiment of this disclosure.

FIG. 9 is a block diagram of a universality detection apparatus for a continual learning model according to an embodiment of this disclosure.

FIG. 10 is a block diagram of an electronic device for universality detection of a continual learning model according to an exemplary embodiment.

### DESCRIPTION OF EMBODIMENTS

Various exemplary embodiments, features, and aspects of this disclosure are described in detail below with reference to the accompanying drawings. Same reference signs in the accompanying drawings represent same or similar elements. Although various aspects of the embodiments are shown in the accompanying drawings, the accompanying drawings are not definitely drawn to scale unless otherwise specified.

The word “exemplary” is used exclusively herein to mean “as an example, embodiment, or illustration.” Any embodiment described as “exemplary” herein is not definitely explained as being preferred or advantageous over other embodiments.

In addition, to better describe this disclosure, many specific details are provided in the following specific implementations. It is noted that this disclosure may also be implemented without some specific details. In some embodiments, methods, means, elements, and circuits well-known in the art are not described in detail, to highlight the essence of this disclosure.

The method provided in the embodiments of this disclosure may relate to an artificial intelligence (AI) technology, and universality detection of a continual learning model may be automatically performed by using the AI technology. For example, the solutions provided in the embodiments of this disclosure relate to technologies such as a natural language processing technology and machine learning/deep learning, and are specifically described by using the following embodiments.

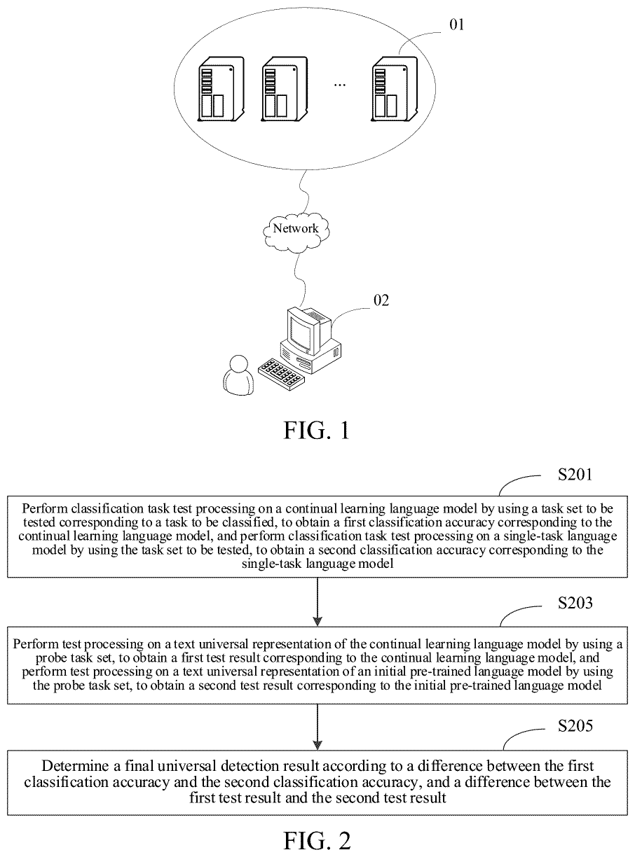

FIG. 1 is a schematic diagram of an application system according to an embodiment of this disclosure. The application system may be applied to a universality detection method for a continual learning model in this disclosure. As shown in FIG. 1, the application system may include at least a server 01 and a terminal 02.

In this embodiment of this disclosure, the server 01 may be configured to perform universality detection processing on the continual learning model. The server 01 may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and big data and an artificial intelligence platform.

In this embodiment of this disclosure, the terminal 02 may be configured to trigger to perform universality detection processing, and receive and display a final universal detection result, and may collect a language text for the server 01 to construct a test task set and a probe task set. The terminal 02 may include physical devices of types such as a smartphone, a desktop computer, a tablet computer, a notebook computer, a smart speaker, a digital assistant, an augmented reality (AR)/virtual reality (VR) device, and a smart wearable device. The physical devices may also include software, such as an application program, running in the physical devices. In this embodiment of this disclosure, an operating system running on the terminal 02 may include, but is not limited to, an Android system, an iOS system, linux, windows, or the like.

In this embodiment of this disclosure, the terminal 02 and the server 01 may be directly or indirectly connected in a wired or wireless communication manner. This is not limited in this disclosure.

In a specific embodiment, when the server 02 is a distributed system, the distributed system may be a blockchain system. When the distributed system is a blockchain system, the distributed system may be formed by a plurality of nodes (computing devices in any form in an access network, for example, a server and a user terminal). A peer-to-peer (P2P) network is formed between the nodes. The P2P protocol is an application-layer protocol running over the transmission control protocol (TCP). In the distributed system, any machine such as a server or a terminal may be added to become a node. The node includes a hardware layer, an intermediate layer, an operating system layer, and an application layer. Specifically, a function of each node in the blockchain system may include:

(1) Routing: Routing is a basic function of the node, and is configured for supporting communication between the nodes.

In addition to a routing function, the node may further have the following function:

(2) Application: An application is deployed in a blockchain, and is configured for implementing a particular service according to an actual service requirement, recording data related to function implementation to form recorded data, adding a digital signature to the recorded data to represent a source of task data, and transmitting the recorded data to other nodes in the blockchain system, for the other nodes to add the recorded data to a temporary block when verifying the source and integrity of the recorded data successfully.

In specific implementations of this disclosure, data related to a user is involved. When the following embodiments of this disclosure are applied to a specific product or technology, user permission or consent needs to be obtained, and collection, use, and processing of the related data need to comply with related laws and regulations and standards of related countries and regions.

FIG. 2 is a flowchart of a universality detection method for a continual learning model according to an embodiment of this disclosure. As shown in FIG. 2, the universality detection method for a continual learning model may include the following operations.

S201: Perform classification task test processing on a continual learning language model by using a task set to be tested corresponding to a task to be classified, to obtain a first classification accuracy corresponding to the continual learning language model, and perform classification task test processing on a single-task language model by using the task set to be tested, to obtain a second classification accuracy corresponding to the single-task language model.

In this embodiment of this disclosure, the task to be classified may be any one of a plurality of classification tasks for continual learning. For example, a quantity of the plurality of classification tasks may be N, and N may be an integer greater than or equal to 2. A continual learning order of the plurality of classification tasks is not limited in the embodiments of this disclosure. After learning of any one of the classification tasks is completed, a corresponding continual learning language model after an initial pre-trained language model completes learning of any one of the classification tasks may be obtained. In other words, the continual learning language model may be a language model after the initial pre-trained language model continually learns to the task to be classified and completes the learning. Based on this, N continual learning language models corresponding to the N classification tasks may be obtained. For example, the initial pre-trained language model may be a bidirectional encoder representation from transformers (BERT) or a DistilBERT (a model obtained by performing knowledge distillation on the BERT). This is not limited in this disclosure.

As an example, the classification task is a basic task in machine learning, and refers to a predictive modeling problem of predicting a class label of a given example in input data, that is, assigning a known label to the input data. The classification task may be classifying an expressed emotion of a text, classifying a subject of a text, classifying a content theme of a text, or the like. This is not limited in this disclosure.

For example, in a case that N=3, for example, the continual learning order is a classification task A, a classification task B, and a classification task C, after the initial pre-trained language model completes learning of the classification task A, a continual learning language model corresponding to the classification task A may be obtained. In this case, the continual learning language model may classify the classification task A and may be referred to as a continual learning language model A. After the initial pre-trained language model sequentially completes learning of the classification task A and the classification task B, a continual learning language model AB may be obtained, and the continual learning language model AB may classify the classification task A and the classification task B. After the initial pre-trained language model sequentially completes learning of the classification task A, the classification task B, and the classification task C, a continual learning language model ABC may be obtained, and the continual learning language model ABC may classify the classification task A, the classification task B, and the classification task C. During the continual learning, the continual learning language model A, the continual learning language model AB, and the continual learning language model ABC may be obtained.

The continual learning language model is obtained by training, based on a sample text corresponding to a classification task obtained through continual learning and a task label corresponding to the classification task, a continual learning model obtained after learning a previous classification task. For example, after the classification task A and the classification task B are continually learned, during learning of the classification task C, a sample text corresponding to the classification task C and a task label, such as a subject label, corresponding to the sample text may be obtained. The sample text corresponding to the classification task C may be inputted into the continual learning language model AB for text representation prediction processing, to obtain a text prediction feature. In this way, the text prediction feature may be inputted into an initial task classifier for subject classification processing, to obtain subject prediction information. Based on this, loss information may be determined according to the subject label and the subject prediction information, so that gradient information may be calculated according to the loss information, and gradient backhaul may be performed. A parameter of the continual learning language model AB and a parameter of the initial task classifier are adjusted until an iteration condition is satisfied. A corresponding continual learning language model AB obtained when the iteration condition is satisfied may be used as the continual learning language model ABC, and a corresponding initial task classifier obtained when the iteration condition is satisfied is used as a first classifier corresponding to the continual learning language model AB. The iteration condition may be an iteration number threshold, a loss threshold, or the like. This is not limited in this disclosure.

The single-task language model may be a language model obtained after the initial pre-trained language model learns the task to be classified alone. Correspondingly, using an example in which the classification tasks are respectively the classification task A, the classification task B, and the classification task C in a case that N=3, the single-task language model may include a single-task language model A, a single-task language model B, and a single-task language model C. The single-task language model A may be a language model that learns the classification task A alone to classify the classification task A alone; the single-task language model B may be a language model that learns the classification task B alone to classify the classification task B alone; and the single-task language model C may be a language model that learns the classification task C alone to classify the classification task C alone.

In this embodiment of this disclosure, the task set to be tested may be any one of a plurality of test task sets. The plurality of test task sets may correspond to the plurality of classification tasks, and can be configured for testing the accuracy of the models (the continual learning language model and the single-task language model) for the plurality of classification tasks. As an example, the test task set may include text data for testing.

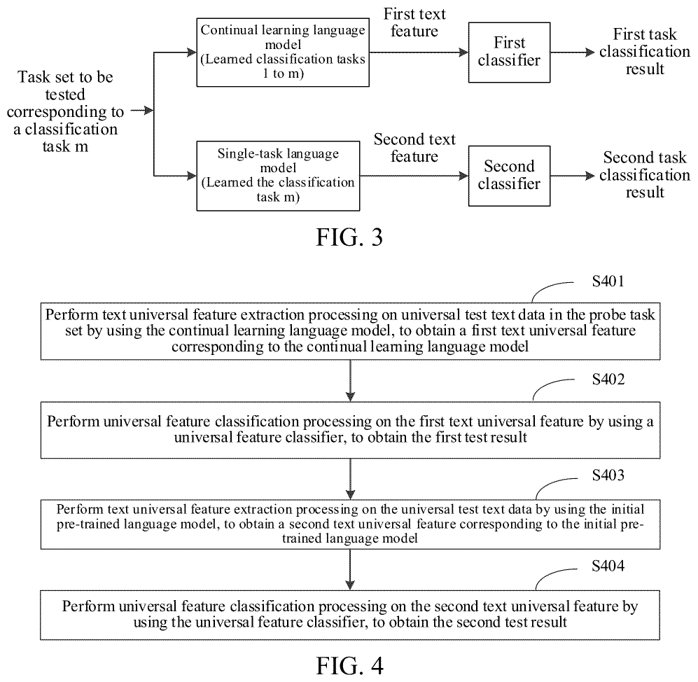

The single-task language model may be pre-trained, or may be trained synchronously with the continual learning language model. The timing of training of the single-task language model is not limited in this disclosure. The single-task language model may be obtained by performing supervised learning based on sample text data and a corresponding classification task label. For example, the single-task language model C may obtain sample text data and a classification task label corresponding to the sample text data. For example, if the classification task C is to classify a subject of a text, the corresponding classification task label may be a text subject label, such as a prose label or a non-prose label. In this way, the sample text data may be inputted into the initial pre-trained language model, to obtain a text vector representation, so that the text vector representation may be classified based on a preset classifier, to obtain a predicted text subject. Based on this, loss information may be determined according to the predicted text subject and the text subject label, so that gradient information may be calculated based on the loss information, and gradient backhaul may be performed. A parameter of the initial pre-trained language model and a parameter of the preset classifier are adjusted until an iteration condition is satisfied. The initial pre-trained language model when the iteration condition is satisfied may be used as the single-task language model C, and the preset classifier when the iteration condition is satisfied may be used as a second classifier corresponding to the single-task language model C, as shown in FIG. 3. The iteration condition may be an iteration number threshold, a loss threshold, or the like. This is not limited in this disclosure. Based on the training manner, the single-task language model A, the single-task language model B, the single-task language model C, a second classifier corresponding to the single-task language model A, a second classifier corresponding to the single-task language model B, and the second classifier corresponding to the single-task language model C may be obtained.

In this embodiment of this disclosure, classification task test processing on the continual learning language model is performed before the continual learning language model is obtained during continual learning and before a next classification task is learned. Therefore, in a case that the initial pre-trained language model continually learns to the task to be classified and completes the learning, classification task test processing may be performed on the continual learning language model by using the task set to be tested corresponding to the task to be classified. The timing of performing classification task test processing on the single-task language model by using the task set to be tested corresponding to the task to be classified is not limited in this disclosure, provided that it is obtained before S203 is needed. In addition, classification task test processing may be performed on the single-task language model by using test task sets respectively corresponding to the N classification tasks, to obtain N second classification accuracies.

In a possible implementation, an output layer may be connected on an output side of a pre-trained language model, to implement classification processing on the plurality of classification tasks. An initial state of the output layer may be an initial task classifier (for example, a multilayer perceptron). In this way, learning and training may be performed on the pre-trained language model and the initial task classifier based on the sample text, to obtain a corresponding continual learning language model and a first classifier corresponding to the continual learning language model, as shown in FIG. 3, For a specific training process, reference may be made to the training process of the continual learning language model, and details are not described herein again. Correspondingly, using an example in which three classification tasks, namely, the classification task A, the classification task B, and the classification task C, are continually learned, during learning of the classification task A, a continual learning language model A and a first classifier corresponding to the continual learning language model A may be obtained; during continual learning of the classification task A and the classification task B, the continual learning language model AB and a first classifier corresponding to the continual learning language model AB are obtained; and during continual learning of the classification task A, the classification task B, and the classification task C, the continual learning language model ABC and a first classifier corresponding to the continual learning language model ABC are obtained.

A manner of determining the first classification accuracy is not limited in the embodiments of this disclosure. In a possible implementation, the manner of determining the first classification accuracy may be shown in FIG. 3. The text data for testing in the task set to be tested is inputted into the continual learning language model for text feature extraction processing, to obtain a first text feature. Next, the first text feature may be inputted into the first classifier for text classification processing, to obtain a first task classification result. In this way, the first task classification result may be compared with the task label of the task set to be tested, to obtain the first classification accuracy. The first classification accuracy may be a ratio of a first quantity of first task classification results that match the task label to a total quantity of first task classification results.

For example, the task to be classified is a classification task m, and a total quantity of pieces of text data for testing in a task set to be tested of the classification task m is 100. After the text data is processed by the continual learning language model and the first classifier, a first quantity of obtained first task classification results that match the task label is 90, and one piece of text data corresponds to one first task classification result. Therefore, a total quantity of first task classification results is 100, and it may be obtained that the first classification accuracy is equal to 90/100. That is, the first classification accuracy of the continual learning language model that continually learns classification tasks 1 to m under the classification task m is 90%.

Correspondingly, during testing of the single-task language model, the text data for testing in the task set to be tested may be inputted into the single-task language model for text feature extraction processing, to obtain a second text feature. Next, the second text feature may be inputted into the second classifier for text classification processing, to obtain a second task classification result. In this way, the second task classification result may be compared with the task label of the task set to be tested, to obtain the second classification accuracy. The second classification accuracy may be a ratio of a second quantity of second task classification results that match the task label to a total quantity of second task classification results.

S203: Perform test processing on a text universal representation of the continual learning language model by using a probe task set, to obtain a first test result corresponding to the continual learning language model, and perform test processing on a text universal representation of an initial pre-trained language model by using the probe task set, to obtain a second test result corresponding to the initial pre-trained language model.

In this embodiment of this disclosure, the probe task set may refer to a task set for testing text universal representations of the continual learning language model and the initial pre-trained language model, and may include universal test text data. The universal test text data is not limited in the embodiments of this disclosure, provided that the text universal representations of the models can be effectively tested. As an example, the universal test text data may include syntactic test text data and semantic test text data. For example, the syntactic test text data may include text data for testing whether two consecutive tokens in a sentence are reversed, determining a maximum depth of a syntax tree of a sentence, determining a singular/plural form of an object and a subject of a sentence, and the like. The semantic test text data may include text data for testing to distinguish whether the order of two coordinating conjunctions is reversed, whether a main verb of a sentence is marked as present or past tense, whether each pair captures a paraphrase/semantic equivalence relationship, and the like. For example, the maximum depth of the syntax tree may be indicated by using textbf.

In this embodiment of this disclosure, the universal test text data may be respectively inputted into the continual learning language model and the initial pre-trained language model for universal feature extraction, and respectively extracted universal features may be inputted into a trained universal feature classifier for classification prediction processing, to obtain a first classification prediction result corresponding to the continual learning language model and a second classification prediction result corresponding to the initial pre-trained language model. In this way, the first classification prediction result may be determined as the first test result, and the second classification prediction result may be determined as the second test result.

Based on the foregoing description, in a possible implementation, the performing test processing on a text universal representation of the continual learning language model by using a probe task set, to obtain a first test result corresponding to the continual learning language model in S203 may include the following operations.

S401: Perform text universal feature extraction processing on universal test text data in the probe task set by using the continual learning language model, to obtain a first text universal feature corresponding to the continual learning language model.

S402: Perform universal feature classification processing on the first text universal feature by using a universal feature classifier, to obtain the first test result.

The performing test processing on a text universal representation of the initial pre-trained language model by using the probe task set, to obtain a second test result corresponding to the initial pre-trained language model in S203 may include the following operations.

S403: Perform text universal feature extraction processing on the universal test text data by using the initial pre-trained language model, to obtain a second text universal feature corresponding to the initial pre-trained language model.

S404: Perform universal feature classification processing on the second text universal feature by using the universal feature classifier, to obtain the second test result.

The first text universal feature and the second text universal feature may be features representing syntax or semantics. This is not limited in this disclosure.

The universal feature classifier may be obtained by training an initial classifier based on sample probe task data and a corresponding universal feature classification label in a case that a parameter of the continual learning language model is fixed. A specific training process herein is described in detail below, and details are not described herein again.

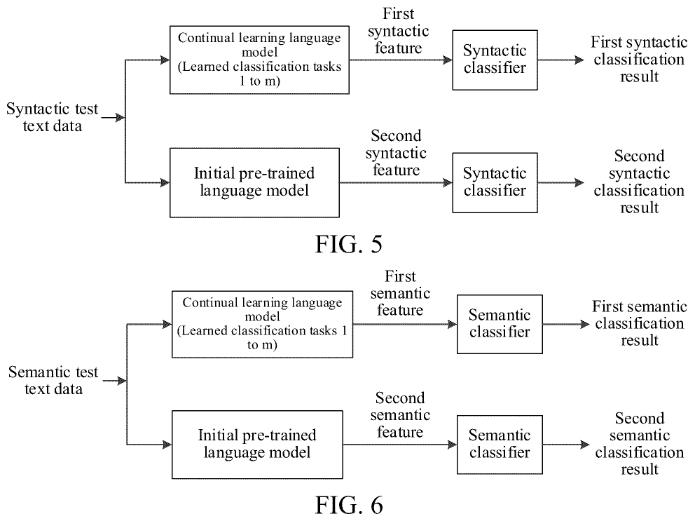

In a possible implementation, the probe task set may include a syntactic task set and a semantic task set, and the universal test text data may include syntactic test text data in the syntactic task set and semantic test text data in the semantic task set. Correspondingly, the first text universal feature may include a first syntactic feature and a first semantic feature; and the universal feature classifier may include a syntactic classifier and a semantic classifier, as shown in FIG. 5 and FIG. 6. In this case, an implementation of performing universal feature classification processing on the first text universal feature by using a universal feature classifier, to obtain the first test result may be: performing syntactic classification task processing on the first syntactic feature by using the syntactic classifier, to obtain a first syntactic classification result; performing semantic classification task processing on the first semantic feature by using the semantic classifier, to obtain a first semantic classification result; and using the first syntactic classification result and the first semantic classification result as the first test result.

Referring to FIG. 5 and FIG. 6, the syntactic test text data and the semantic test text data may be respectively inputted into the initial pre-trained language model for syntactic and semantic feature extraction processing, to obtain the second text universal feature corresponding to the initial pre-trained language model. The second text universal feature may include a second syntactic feature and a second semantic feature. In this case, a manner of performing universal feature classification processing on the second text universal feature by using the universal feature classifier, to obtain the second test result may be: performing syntactic classification task processing on the second syntactic feature by using the syntactic classifier, to obtain a second syntactic classification result, as shown in FIG. 5. Next, semantic classification task processing is performed on the second semantic feature by using the semantic classifier, to obtain a second semantic classification result. In this way, the second syntactic classification result and the second semantic classification result may be used as the second test result.

The first syntactic classification result and the second syntactic classification result may include that an object and a subject of a sentence are in a singular form, an object and a subject of a sentence are in a plural form, or the like. The first semantic classification result and the second semantic classification result may include the order of two coordinating conjunctions being reversed, the order of two coordinating conjunctions being not reversed, or the like. These are not limited in this disclosure.

S205: Determine a final universal detection result according to a difference between the first classification accuracy and the second classification accuracy, and a difference between the first test result and the second test result.

The final universal detection result may be configured for indicating an association relationship between a universal representation capability of the initial pre-trained language model after continually learning the plurality of classification tasks and a universal representation capability of a non-continual learning model, such as a difference between the universal representation capabilities and a change trend of the universal representation capabilities. This is not limited in this disclosure. The non-continual learning model may include the initial pre-trained language model and the single-task language model.

In a possible implementation, S205 may include: determining a first universal detection result according to the difference between the first classification accuracy and the second classification accuracy. In addition, a second universal detection result may be determined according to the difference between the first test result and the second test result. In this way, statistical calculations may be performed on the first universal detection results and the second universal detection results respectively corresponding to the plurality of classification tasks, to obtain the final universal detection result.

A manner of determining the first universal detection result and the second universal detection result is not limited in the embodiments of this disclosure. In a possible implementation, the difference between the first classification accuracy and the second classification accuracy may be used as the first universal detection result, and the difference between the first test result and the second test result may be used as the second universal detection result. In this manner, the first universal detection result and the second universal detection result can be determined more conveniently and quickly, thereby improving universality detection efficiency.

In an implementation, this embodiment of this disclosure further provides another manner of determining the second universal detection result. A difference value between the first test result and the second test result is used as universal difference information; and a ratio of the universal difference information to the second test result is determined as the second universal detection result. In this manner, a more accurate and appropriate second universal detection result can be obtained, to ensure the universality detection accuracy.

A manner of performing statistical calculations on the first universal detection results and the second universal detection results respectively corresponding to the plurality of classification tasks, to obtain the final universal detection result may be: determining the final universal detection result based on a statistical result obtained by calculating the first universal detection result and the second universal detection result respectively. For example, a statistical result of the first universal detection results respectively corresponding to the plurality of classification tasks and a statistical result of second universal detection results respectively corresponding to the plurality of classification tasks may be used as the final universal detection result. The statistical result may be a result of statistical calculations such as averaging and summation. This is not limited in this disclosure. By respectively performing classification task test processing on a continual learning language model and a single-task language model by using a task set to be tested corresponding to a task to be classified, a classification accuracy difference between the continual learning language model and the single-task language model is obtained, and by respectively performing test processing on text universal representations of the continual learning language model and an initial pre-trained language model by using a probe task set, a difference between the continual learning language model and the initial pre-trained language model in a text universal representation capability is obtained. Therefore, a final universal detection result of the continual learning language model that continually learns to the task to be classified may be determined based on the two differences, so that the final universal detection result not only can represent changes in a classification task universal representation between continual learning and non-continual learning, but also can represent changes in the text universal representation between the continual learning language model and the initial pre-trained language model, making the final universal detection result more precise, and explaining changes in the universality of the continual learning model more accurately and effectively. Based on this, by using the final universal detection result, in a case that a single model is used to implement a plurality of classification functions, a text universal representation capability of the single model can be effectively and flexibly controlled, so that not only the diversity of applications of the single model can be increased, to avoid training a model for each classification task, but also the requirement of the plurality of classification tasks of the continual learning model for the text universal representation can be satisfied, and the classification accuracy of the continual learning model on the plurality of classification tasks can be improved.

In this embodiment of this disclosure, the universal feature classifier corresponds to the classification task. The universal feature classifier may be obtained by training the initial classifier based on the sample probe task data and the corresponding universal feature classification label in a case that the parameter of the continual learning language model is fixed after any classification task is continually learned.

Using the foregoing three classification tasks as an example, during continual learning, the three continual learning language models, namely, the continual learning language model A, the continual learning language model AB, and the continual learning language model ABC, may be obtained. In this way, three universal feature classifiers respectively corresponding to the continual learning language model A, the continual learning language model AB, and the continual learning language model ABC, for example, a universal feature classifier A corresponding to the continual learning language model A, a universal feature classifier AB corresponding to the continual learning language model AB, and a universal feature classifier ABC corresponding to the continual learning language model ABC, may be obtained. In this process, for example, the pre-trained language model completes continual learning of the classification task A and the classification task B, and in this case, the continual learning language model AB is obtained. Next, a model parameter of the continual learning language model AB may be fixed, and subsequent learning of the classification task C is not performed. In this case, the initial classifier (for example, an initial multilayer perceptron) may be connected behind (on the output side of) the continual learning language model AB, thereby training the initial classifier by using the sample probe task data and the corresponding universal feature classification label, to obtain the universal feature classifier AB that satisfies the iteration condition and corresponds to the continual learning language model AB.

Based on the foregoing description, using a training process of a universal feature classifier corresponding to any classification task (target task) as an example, the universal feature classifier may be obtained through training by using the following operations:

obtaining the continual learning language model corresponding to the task to be classified in a case that the initial pre-trained language model continually learns to the task to be classified and completes the learning. In this way, the sample probe task data may be inputted into the continual learning language model, and text universal feature extraction processing may be performed on the sample probe task data by using the continual learning language model, to obtain a sample universal feature. In addition, universal feature classification processing may be performed on the sample universal feature based on the initial classifier, to obtain a sample universal feature classification result. Next, loss information may be determined according to the sample universal feature classification result and the universal feature classification label corresponding to the sample probe task data. Finally, parameter adjustment may be performed on the initial classifier by using the loss information until a training iteration condition is satisfied, to obtain the universal feature classifier.

A manner of obtaining the continual learning language model corresponding to the task to be classified may be: freezing a model parameter of the initial pre-trained language model that completes continual learning of the task to be classified, to obtain the continual learning language model corresponding to the task to be classified.

The loss information is configured for representing a difference between the sample universal feature classification result outputted based on the initial classifier and a real classification result (that is, the universal feature classification label), to represent the accuracy of the initial classifier, thereby performing parameter adjustment on the initial classifier. A manner of determining the loss information may be: comparing the sample universal feature classification result with the universal feature classification label, and using a classification error rate as the loss information; or calculating a loss between the sample universal feature classification result and the universal feature classification label by using a preset loss function, to obtain the loss information. The preset loss function is not limited in this disclosure.

A manner of performing parameter adjustment on the initial classifier by using the loss information to obtain the universal feature classifier may be: determining whether the training iteration condition is satisfied; if the training iteration condition is not satisfied, determining the gradient information according to the loss information, so that parameter adjustment may be performed on a parameter of the initial classifier by using gradient backhaul; and going back to the foregoing operation of inputting the sample probe task data into the continual learning language model, to iterate the foregoing training process until the training iteration condition is satisfied. In this way, a corresponding initial classifier when the training iteration condition is satisfied may be used as the universal feature classifier.

In a training process of the universal feature classifier, the parameter of the continual learning language model is not adjusted.

In an implementation, the sample probe task data may include sample syntactic data and/or sample semantic data. Based on this, the universal feature classifier obtained through training may include a syntactic classifier and/or a semantic classifier. In this case, a training process of the syntactic classifier may include: inputting the sample syntactic data into the continual learning language model for syntactic feature extraction processing, to obtain a sample syntactic feature. In this way, syntactic feature classification processing may be performed on the sample syntactic feature based on the initial classifier, to obtain a sample syntactic classification result; and loss information is determined according to the sample syntactic classification result and a syntactic classification label corresponding to the sample syntactic data. Further, parameter adjustment may be performed on the initial classifier by using the loss information until the training iteration condition is satisfied, to obtain the syntactic classifier.

Based on a training process similar to that of the syntactic classifier, the initial classifier may be trained based on the sample semantic data, to obtain the semantic classifier. In a possible implementation, the sample semantic data may be inputted into the continual learning language model for semantic feature extraction processing, to obtain a sample semantic feature. In this way, semantic feature classification processing may be performed on the sample semantic feature based on the initial classifier, to obtain a sample semantic classification result; and loss information is determined according to the sample semantic classification result and a semantic classification label corresponding to the sample semantic data. Next, parameter adjustment may be performed on the initial classifier by using the loss information until the training iteration condition is satisfied, to obtain the semantic classifier.

The syntactic classification label may include labels such as two consecutive tokens in a sentence being reversed, two consecutive tokens in a sentence being not reversed, a maximum depth of a syntax tree, an object and a subject of a sentence being in a singular form, and an object and a subject of a sentence being in a plural form. The semantic classification label may include labels such as the order of two coordinating conjunctions being reverse, the order of two coordinating conjunctions being not reverse, a main verb of a sentence being marked as present tense, and a main verb of a sentence being marked as past tense. The syntactic classification label and the semantic classification label are not limited in this disclosure. The sample syntactic data and the sample semantic data may be set according to a syntactic representation and a semantic representation that need to be detected, to set a corresponding syntactic classification label and a corresponding semantic classification label for the sample syntactic data and the sample semantic data.

The initial classifier is connected to the last layer of the continual learning language model. In some embodiments, the initial classifier may be connected to each layer of the continual learning language model, to obtain a universal feature classifier of each layer through training. For example, if the BERT model has 12 layers, under the task to be classified, 12 universal feature classifiers may be obtained through training. For a training process of the universal feature classifier on each layer, reference may be made to the foregoing training process of the universal feature classifier. That is, in each iteration process, 12 pieces of loss information may be obtained. In this way, a model parameter of a corresponding layer in the continual learning language model may be adjusted and parameters of 12 initial classifiers may be correspondingly adjusted based on the 12 pieces of loss information. Details are not described herein again. Correspondingly, in a case that the universal feature classifier includes the syntactic classifier and the semantic classifier, based on such a training manner in which each layer of the continual learning language model is connected to the initial classifier, after learning of each classification task is completed, 12 syntactic classifiers and 12 semantic classifiers may be obtained.

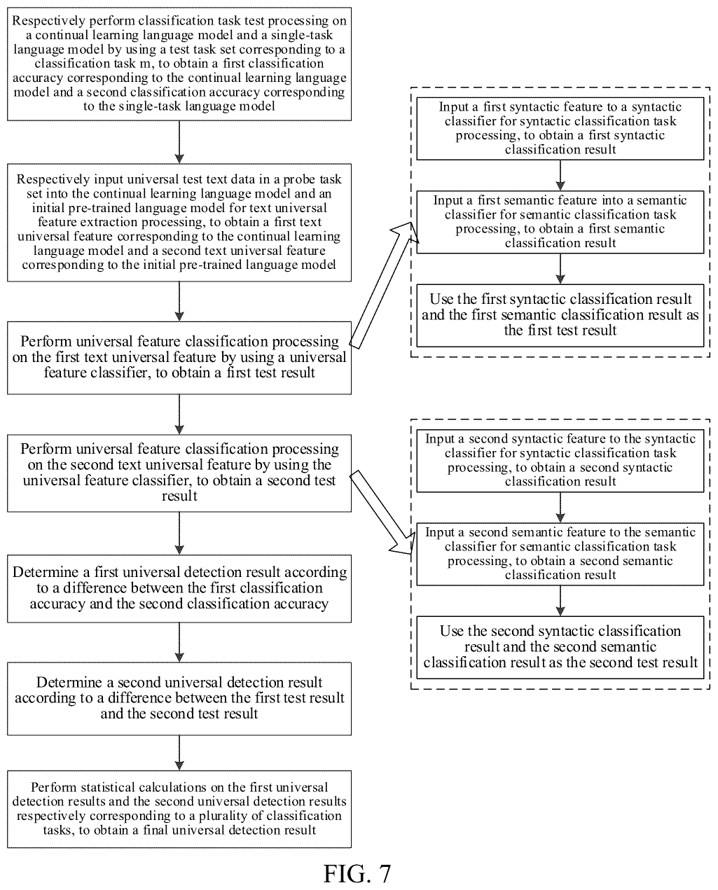

Referring to FIG. 7, in an application example, assuming that the plurality of classification tasks are classification tasks 1 to N, N being greater than or equal to 2, an example in which the task to be classified is a classification task m, m ranging from 1 to N, is used. Classification task test processing may be respectively performed on a continual learning language model and a single-task language model by using a test task set corresponding to the classification task m, to obtain a first classification accuracy corresponding to the continual learning language model and a second classification accuracy corresponding to the single-task language model. The continual learning language model may be obtained after a pre-trained language model continually learns the classification tasks 1 to m. Specifically, the test task set corresponding to the classification task m may be inputted into the continual learning language model for text representation processing, to obtain a first text feature, so that the first text feature may be inputted into a first classifier for classification task prediction processing, to obtain a first task classification result. In this way, the first task classification result may be compared with a task label corresponding to text data for testing in the test task set corresponding to the classification task m, to obtain the first classification accuracy. The first classification accuracy may be a ratio of a first quantity of first task classification results that match the task label to a total quantity of first task classification results. Correspondingly, during testing of the single-task language model, the text data for testing in the test task set corresponding to the classification task m may be inputted into the single-task language model (a pre-trained language model only learning the classification task m) for text feature extraction processing, to obtain a second text feature. Further, the second text feature may be inputted into a second classifier for text classification processing, to obtain a second task classification result. In this way, the second task classification result may be compared with the task label, to obtain the second classification accuracy. The second classification accuracy may be a ratio of a second quantity of second task classification results that match the task label to a total quantity of second task classification results.

In this embodiment of this disclosure, the universal test text data in the probe task set may be respectively inputted into the continual learning language model and an initial pre-trained language model for text universal feature extraction processing, to obtain a first text universal feature corresponding to the continual learning language model and a second text universal feature corresponding to the initial pre-trained language model. Specifically, the universal test text data may include syntactic test text data and semantic test text data. Based on this, the syntactic test text data may be inputted into the continual learning language model for syntactic representation processing, to obtain a first syntactic feature. Further, the first syntactic feature may be inputted into a syntactic classifier for syntactic classification prediction processing, to obtain a first syntactic classification result. In addition, the semantic test text data may be inputted into the continual learning language model for semantic representation processing, to obtain a first semantic feature, so that the first semantic feature may be inputted into a semantic classifier for semantic classification task processing, to obtain a first semantic classification result. Further, the first syntactic classification result and the first semantic classification result may be used as the first test result.

Next, a first universal detection result may be determined according to a difference between the first classification accuracy and the second classification accuracy; and the second universal detection result may be determined according to a difference between the first test result and the second test result. Therefore, statistical calculations may be performed on the first universal detection results and the second universal detection results respectively corresponding to the plurality of classification tasks, to obtain the final universal detection result.

In an example, the final universal detection result may be calculated through the following formula, that is, the final universal detection result may include the following GD, SynF, and SemF.

$$G D = \frac{1}{N - 1} {\sum }_{m = 2}^{N} ( {R}_{*}^{m} - {R}^{m , m} ) \qquad ( 1 )$$

$$SynF = \frac{1}{\vert {p}^{S y n} \vert} {\sum }_{{p}^{s} ∈ {p}^{S y n}} \frac{1}{N} {\sum }_{m = 1}^{N} \frac{{S}_{y}^{* , s} - {S}_{y}^{m , s}}{{S}_{y}^{* , s}} \qquad ( 2 )$$

$$SemF = \frac{1}{\vert {p}^{S e m} \vert} {\sum }_{{p}^{s} ∈ {p}^{S e m}} \frac{1}{N} {\sum }_{m = 1}^{N} \frac{{S}_{e}^{* , s} - {S}_{e}^{m , s}}{{S}_{e}^{* , s}} \qquad ( 3 )$$

GD represents a first universal detection result, R_{*}^{m} represents a second classification accuracy, and R^{m,m} represents a first classification accuracy; SynF and SemF represent second universal detection results, SynF may represent a syntactic universal detection result, and SemF may represent a semantic universal detection result; p^{s} may represent a probe task set, p^{Syn} may represent syntactic test text data, S_{y}^{*,s} may represent a second syntactic classification result, and S_{y}^{m,s} may represent a first syntactic classification result corresponding to the classification task continually learned; and p^{Sem} may represent semantic test text data, Sₑ^{*,s} may represent a second semantic classification result, and sₑ^{m,s} may represent a first semantic classification result corresponding to the classification task m continually learned. |p^{Syn}| may represent a quantity of syntactic tasks that can be tested in the syntactic task set, that is, a quantity of types of tasks for testing syntax; and |p^{Sem}| represents a quantity of semantic tasks that can be tested in the semantic task set, that is, a quantity of types of tasks for testing semantics.

Based on the foregoing formula, statistical calculations may be performed on the syntax and the semantics. For example, in the formula (2), a difference value between the second syntactic classification result and the first syntactic classification result may be calculated, and a first ratio of the difference to the second syntactic classification result is calculated. In this way, statistical calculations may be performed on first ratios under the plurality of classification tasks, to obtain an average value of the first ratios, as the syntactic universal detection result. Correspondingly, the semantic universal detection result may be calculated according to the formula (3). For example, a difference value between the second semantic classification result and the first semantic classification result may be calculated, and a second ratio of the difference to the second semantic classification result is calculated. In this way, statistical calculations may be performed on second ratios under the plurality of classification tasks, to obtain an average value of the second ratios, as the semantic universal detection result. In this way, the syntactic universal detection result and the semantic universal detection result may be used as the second universal detection result. In this way, the first universal detection result and the second universal detection result may be used as the final universal detection result.

In a possible implementation, a change in a universal representation capability of the pre-trained language model during continual learning may be analyzed by using the final universal detection result. A trend graph or change information of the change may be provided, and the trend graph or the change information of the change may be fed back to the terminal, to display and notify the trend graph or the change information of the change. Alternatively, a universal representation threshold may be preset, and the universal representation threshold may be configured for indicating a critical value when the universal representation capability satisfies a universal requirement. Based on this, after continual learning of a classification task is completed, an obtained final universal detection result is compared with the universal representation threshold. If the final universal detection result is greater than or equal to the universal representation threshold, continual learning may be stopped, because the universal representation capability has been degraded, and does not satisfy the universal requirement or just satisfies the universal requirement. If the final universal detection result is less than the universal representation threshold, the pre-trained language model continually learning can satisfy the universal requirement, to further continue to learn another classification task. This can effectively balance a quantity of classification tasks continually learned and the universal representation capability. The universal representation threshold may include a GD threshold, a SynF threshold, and a SemF threshold. Based on this, the final universal detection result being greater than or equal to the universal representation threshold may refer to being greater than or equal to at least one of the GD threshold, the SynF threshold, or the SemF threshold. The final universal detection result being less than the universal feature threshold may refer to GD, SynF, and SemF being all less than the corresponding GD threshold, SynF threshold, and SemF threshold. This is not limited in this disclosure.

Referring to the following Table 1, for different pre-trained language models, a positive correlation is presented between GD, SemF, and SynF, indicating that different detection indicators can mutually support changes of the universality of the models.

TABLE 1

| BERT | | | DistilBERT | | |
|---|---|---|---|---|---|
| GD | SynF | SemF | GD | SynF | SemF |
| 0.67 | 6.50 | 0.72 | 1.61 | 18.83 | 9.95 |
| 0.37 | 2.96 | −1.00 | 0.85 | 15.67 | 9.32 |
| 0.92 | 5.26 | 1.53 | 1.41 | 18.32 | 11.12 |
| 0.73 | 5.62 | 1.75 | 0.96 | 16.33 | 8.89 |
| 0.61 | 4.72 | 0.65 | 1.66 | 19.34 | 10.03 |
| 0.66 | 5.73 | 0.94 | 0.80 | 13.21 | 9.04 |

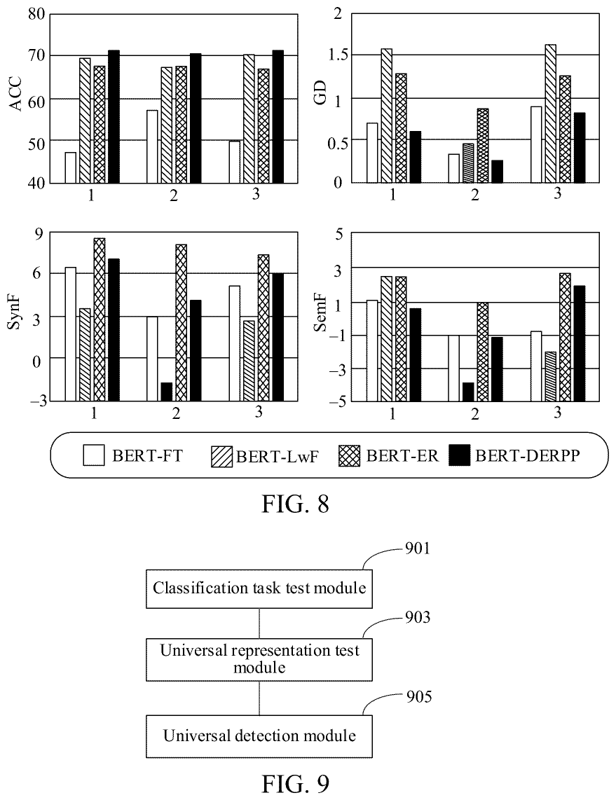

Referring to FIG. 8, ACC represents a classification accuracy of testing after the continual learning language model completes learning of the plurality of classification tasks, that is, an average accuracy. Catastrophic forgetting can be effectively alleviated in a plurality of continual learning manners, so that a relatively high classification accuracy can still be maintained after continual learning. The plurality of continual learning manners may include manners such as BERT-FT, BERT-LwF, BERT-ER, and BERT-DERPP. The BERT-FT directly optimizes a model on a training task by adding a linear classification layer based on the BERT. The method is a baseline model. The BERT-LwF controls, based on the BERT-FT, a model parameter not to deviate greatly to alleviate catastrophic forgetting. The BERT-ER replays memory data based on the BERT-FT to alleviate catastrophic forgetting of a model. The BERT-DERPP combines any two of the foregoing strategies. It can be seen from FIG. 8 that, according to the universality detection method for a continual learning model in this disclosure, changes in universal knowledge in different continual learning manners can be precisely determined, and during continual learning, a quantity of classification tasks can be controlled according to the changes in the universal knowledge, so that the continual learning language model can maintain a capability of processing more downstream tasks.

FIG. 9 is a block diagram of a universality detection apparatus for a continual learning model according to an embodiment of this disclosure. As shown in FIG. 9, the apparatus may include:
a classification task test module 901, configured to perform classification task test processing on a continual learning language model by using a task set to be tested corresponding to a task to be classified, to obtain a first classification accuracy corresponding to the continual learning language model, and perform classification task test processing on a single-task language model by using the task set to be tested, to obtain a second classification accuracy corresponding to the single-task language model, the continual learning language model being a language model obtained after an initial pre-trained language model continually learns to the task to be classified and completes the learning; the single-task language model being a language model obtained after the initial pre-trained language model learns the task to be classified alone; and the task to be classified being any one of a plurality of classification tasks for continual learning;
a universal representation test module 903, configured to perform test processing on a text universal representation of the continual learning language model by using a probe task set, to obtain a first test result corresponding to the continual learning language model, and perform test processing on a text universal representation of the initial pre-trained language model by using the probe task set, to obtain a second test result corresponding to the initial pre-trained language model; and
a universal detection module 905, configured to determine a final universal detection result according to a difference between the first classification accuracy and the second classification accuracy, and a difference between the first test result and the second test result, the final universal detection result being configured for indicating an association relationship between a universal representation capability of the initial pre-trained language model after continually learning the plurality of classification tasks and a universal representation capability of a non-continual learning model, the non-continual learning model including the initial pre-trained language model and the single-task language model.

By respectively performing classification task test processing on a continual learning language model and a single-task language model by using a task set to be tested corresponding to a task to be classified, a classification accuracy difference between the continual learning language model and the single-task language model is obtained, and by respectively performing test processing on text universal representations of the continual learning language model and an initial pre-trained language model by using a probe task set, a difference between the continual learning language model and the initial pre-trained language model in a text universal representation capability is obtained. Therefore, a final universal detection result of the continual learning language model that continually learns to the task to be classified may be determined based on the two differences, so that the final universal detection result not only can represent changes in a classification task universal representation between continual learning and non-continual learning, but also can represent changes in the text universal representation between the continual learning language model and the initial pre-trained language model, making the final universal detection result more precise, and explaining changes in the universality of the continual learning model more accurately and effectively. Based on this, by using the final universal detection result, in a case that a single model is used to implement a plurality of classification functions, a text universal representation capability of the single model can be effectively and flexibly controlled, so that not only the diversity of applications of the single model can be increased, to avoid training a model for each classification task, but also the requirement of the plurality of classification tasks of the continual learning model for the text universal representation can be satisfied, and the classification accuracy of the continual learning model on the plurality of classification tasks can be improved.

In a possible implementation, the universal representation test module 903 may include:
a universal feature extraction unit, configured to perform text universal feature extraction processing on universal test text data in the probe task set by using the continual learning language model, to obtain a first text universal feature corresponding to the continual learning language model; and perform text universal feature extraction processing on the universal test text data by using the initial pre-trained language model, to obtain a second text universal feature corresponding to the initial pre-trained language model;
a first test unit, configured to perform universal feature classification processing on the first text universal feature by using a universal feature classifier, to obtain the first test result, the universal feature classifier being obtained by training an initial classifier based on sample probe task data and a corresponding universal feature classification label in a case that a parameter of the continual learning language model is fixed; and
a second test unit, configured to perform universal feature classification processing on the second text universal feature by using the universal feature classifier, to obtain the second test result.

In a possible implementation, the probe task set includes a syntactic task set and a semantic task set, and the universal test text data includes syntactic test text data in the syntactic task set and semantic test text data in the semantic task set; correspondingly, the first text universal feature includes a first syntactic feature and a first semantic feature; and the universal feature classifier includes a syntactic classifier and a semantic classifier; and the first test unit may include:
a first syntactic classification subunit, configured to perform syntactic classification task processing on the first syntactic feature by using the syntactic classifier, to obtain a first syntactic classification result;
a first semantic classification subunit, configured to perform semantic classification task processing on the first semantic feature by using the semantic classifier, to obtain a first semantic classification result; and
a first test subunit, configured to use the first syntactic classification result and the first semantic classification result as the first test result.

In a possible implementation, the second text universal feature includes a second syntactic feature and a second semantic feature; and the second test unit may include:
a second syntactic classification subunit, configured to perform syntactic classification task processing on the second syntactic feature by using the syntactic classifier, to obtain a second syntactic classification result;
a second semantic classification subunit, configured to perform semantic classification task processing on the second semantic feature by using the semantic classifier, to obtain a second semantic classification result; and
a second test subunit, configured to use the second syntactic classification result and the second semantic classification result as the second test result.

In a possible implementation, the apparatus may further include the following modules for training the universal feature classifier:
a continual learning language model obtaining module, configured to obtain the continual learning language model corresponding to the task to be classified in a case that the initial pre-trained language model continually learns to the task to be classified and completes the learning;
a feature extraction module, configured to perform text universal feature extraction processing on the sample probe task data by using the continual learning language model, to obtain a sample universal feature;
a universal feature classification module, configured to perform universal feature classification processing on the sample universal feature based on the initial classifier, to obtain a sample universal feature classification result;
a loss information determining module, configured to determine loss information according to the sample universal feature classification result and the universal feature classification label corresponding to the sample probe task data; and
a parameter adjustment module, configured to perform parameter adjustment on the initial classifier by using the loss information until a training iteration condition is satisfied, to obtain the universal feature classifier.

In a possible implementation, the classification task test module 901 may include:
a first universal detection result determining unit, configured to determine a first universal detection result according to the difference between the first classification accuracy and the second classification accuracy;
a second universal detection result determining unit, configured to determine a second universal detection result according to the difference between the first test result and the second test result; and
a final universal detection result obtaining unit, configured to perform statistical calculations on the first universal detection results and the second universal detection results respectively corresponding to the plurality of classification tasks, to obtain the final universal detection result.

In a possible implementation, the second universal detection result determining unit may include:
a universal difference information determining subunit, configured to use the difference between the first test result and the second test result as universal difference information; and
a second universal detection result determining subunit, configured to determine a ratio of the universal difference information to the second test result as the second universal detection result.

Specific manners for the modules and units of the apparatus in the foregoing embodiment to perform operations have been described in detail in the embodiments related to the method, and are not described in detail herein.

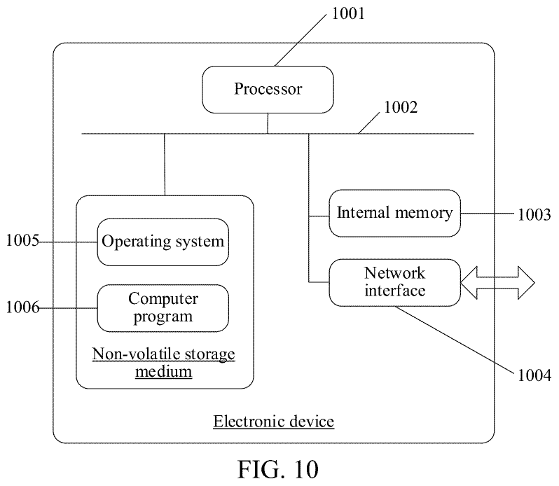

FIG. 10 is a block diagram of an electronic device according to an embodiment of this disclosure. The electronic device may perform the universality detection method for a continual learning model. The electronic device may be a server, and a diagram of an internal structure of the server may be shown in FIG. 10. The electronic device includes a processor 1001, a memory, and a network interface 1004 that are connected through a system bus 1002. The processor of the electronic device is configured to provide computing and control capabilities. The memory of the electronic device includes a non-volatile storage medium and an internal memory 1003. The non-volatile storage medium has an operating system 1005 and a computer program 1006 stored therein. The internal memory 1003 provides an environment for running of the operating system 1005 and the computer program 1006 in the non-volatile storage medium. The network interface of the electronic device is configured to connect to and communicate with an external terminal through a network. When the computer program is executed by the processor, a universality detection method for a continual learning model is implemented.

It is noted that the structure shown in FIG. 10 is only a block diagram of a partial structure related to the solution in this disclosure, and does not constitute a limitation on the electronic device to which the solution in this disclosure is applied. Specifically, the electronic device may include more components or fewer components than those shown in FIG. 10, or some components may be combined, or a different component deployment may be used.

In an exemplary embodiment, an electronic device is further provided. The electronic device includes: processing circuitry (e.g., a processor); and a memory (or non-transitory computer readable storage medium), configured to store computer program instructions, the processor being configured to execute the computer program instructions, to implement the universality detection method for a continual learning model in the embodiments of this disclosure.

In an exemplary embodiment, a non-volatile computer-readable storage medium is further provided. The non-volatile computer-readable storage medium has computer program (instructions stored therein, the computer program instructions, when executed by a processor, causing an electronic device to perform the universality detection method for a continual learning model in the embodiments of this disclosure.

In an exemplary embodiment, a computer program product is further provided. The computer program product includes computer program instructions, the computer program instructions, when executed by a processor, causing an electronic device to perform the universality detection method for a continual learning model in the embodiments of this disclosure.

It is noted that all or a part of the processes of the method in the foregoing embodiments may be implemented by a computer program instructing relevant hardware. The computer program may be stored in a non-volatile computer-readable storage medium. When the computer program is executed, the processes of the method in the foregoing embodiments are performed. Any reference to a memory, storage, database, or other media used in the embodiments provided in this disclosure may include a non-volatile and/or volatile memory. The non-volatile memory may include a read-only memory (ROM), a programmable ROM (PROM), an electrically programmable ROM (EPROM), an electrically erasable programmable ROM (EEPROM), a flash memory, or the like. The volatile memory may include a random access memory (RAM) or an external cache memory.

As an illustration instead of a limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a rambus direct RAM (RDRAM), a direct rambus dynamic RAM (DRDRAM), and a rambus dynamic RAM (RDRAM).

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

This disclosure is intended to cover any variation, use, or adaptive change of this disclosure. These variations, uses, or adaptive changes follow the universal principles of this disclosure and include common universal knowledge or common technical means in the art that are not disclosed in this disclosure. The specification and the embodiments are considered as merely exemplary, and the real scope and spirit of this disclosure are pointed out in the following claims.

This disclosure is not limited to the precise structures described above and shown in the accompanying drawings, and various modifications and changes can be made without departing from the scope of this disclosure.

What is claimed is:

1. A method of universality detection for a continual learning model, the method comprising:
performing respective classification task test processing on a continual learning language model and a single-task language model by using a first task set associated with a first classification task, to obtain a first classification accuracy of the continual learning language model and a second classification accuracy of the single-task language model, the continual learning language model being obtained after an initial pre-trained language model continually learns one or more classification tasks until a completion of the first classification task, the single-task language model being obtained after the initial pre-trained language model learns the first classification task alone;
performing a first test processing on a first text universal representation of the continual learning language model by using a probe task set, to obtain a first test result associated with the continual learning language model;
performing a second test processing on a second text universal representation of the initial pre-trained language model by using the probe task set, to obtain a second test result associated with the initial pre-trained language model; and
determining a final universal detection result according to a classification accuracy difference between the first classification accuracy and the second classification accuracy, and a test result difference between the first test result and the second test result, the final universal detection result indicating an association relationship between a universal representation capability of the continual learning language model and a universal representation capability of a non-continual learning model, the non-continual learning model comprising the initial pre-trained language model and the single-task language model.

2. The method according to claim 1, wherein:
the performing the first test processing comprises:
performing a first text universal feature extraction processing with universal test text data in the probe task set being input into the continual learning language model, to obtain a first text universal feature associated with the continual learning language model; and
performing a first universal feature classification processing with the first text universal feature being input into a universal feature classifier, to obtain the first test result, the universal feature classifier being obtained by training an initial classifier based on sample probe task data and a universal feature classification label corresponding to the sample probe task data when parameters of the continual learning language model are fixed; and
the performing the second test processing comprises:
performing a second text universal feature extraction processing with the universal test text data being input into the initial pre-trained language model, to obtain a second text universal feature associated with the initial pre-trained language model; and
performing a second universal feature classification processing with the second text universal feature being input into the universal feature classifier, to obtain the second test result.

3. The method according to claim 2, wherein the probe task set comprises a syntactic task set and a semantic task set, and the universal test text data comprises syntactic test text data in the syntactic task set and semantic test text data in the semantic task set; the first text universal feature comprises a first syntactic feature and a first semantic feature; and the universal feature classifier comprises a syntactic classifier and a semantic classifier;
the performing the first universal feature classification processing comprises:
performing a first syntactic classification task processing with the first syntactic feature being input into the syntactic classifier, to obtain a first syntactic classification result;
performing a first semantic classification task processing with the first semantic feature being input into the semantic classifier, to obtain a first semantic classification result; and
using the first syntactic classification result and the first semantic classification result as the first test result.

4. The method according to claim 3, wherein the second text universal feature comprises a second syntactic feature and a second semantic feature; and the performing the second universal feature classification processing comprises:
performing a second syntactic classification task processing with the second syntactic feature being input into the syntactic classifier, to obtain a second syntactic classification result;
performing a second semantic classification task processing with the second semantic feature being input into the semantic classifier, to obtain a second semantic classification result; and
using the second syntactic classification result and the second semantic classification result as the second test result.

5. The method according to claim 2, further comprising:
obtaining the continual learning language model when the initial pre-trained language model continually learns the one or more classification tasks until the completion of the first classification task;
performing a text universal feature extraction processing with the sample probe task data being input into the continual learning language model, to obtain a sample universal feature;
performing a universal feature classification processing with the sample universal feature being processed by the initial classifier, to obtain a sample universal feature classification result;
determining loss information according to the sample universal feature classification result and the universal feature classification label corresponding to the sample probe task data; and
performing parameter adjustment on the initial classifier based on the loss information until a training iteration condition is satisfied, to obtain the universal feature classifier.

6. The method according to claim 1, wherein the determining the final universal detection result comprises:
determining a first universal detection result associated with the first classification task according to the classification accuracy difference between the first classification accuracy and the second classification accuracy;
determining a second universal detection result associated with the first classification task according to the test result difference between the first test result and the second test result; and
performing statistical calculations on first universal detection results respectively associated with the one or more classification tasks and second universal detection results respectively associated with the one or more classification tasks, to obtain the final universal detection result.

7. The method according to claim 6, wherein the determining the second universal detection result comprises:
using a difference value between the first test result and the second test result as a universal difference; and
determining a ratio of the universal difference to the second test result as the second universal detection result.

8. An apparatus of universality detection for a continual learning model, comprising processing circuitry configured to:
perform respective classification task test processing on a continual learning language model and a single-task language model by using a first task set associated with a first classification task, to obtain a first classification accuracy of the continual learning language model and a second classification accuracy of the single-task language model, the continual learning language model being obtained after an initial pre-trained language model continually learns one or more classification tasks until a completion of the first classification task, the single-task language model being obtained after the initial pre-trained language model learns the first classification task alone;
perform a first test processing on a first text universal representation of the continual learning language model by using a probe task set, to obtain a first test result associated with the continual learning language model;
perform a second test processing on a second text universal representation of the initial pre-trained language model by using the probe task set, to obtain a second test result associated with the initial pre-trained language model; and
determine a final universal detection result according to a classification accuracy difference between the first classification accuracy and the second classification accuracy, and a test result difference between the first test result and the second test result, the final universal detection result indicating an association relationship between a universal representation capability of the continual learning language model and a universal representation capability of a non-continual learning model, the non-continual learning model comprising the initial pre-trained language model and the single-task language model.

9. The apparatus according to claim 8, wherein the processing circuitry is configured to:
perform a first text universal feature extraction processing with universal test text data in the probe task set being input into the continual learning language model, to obtain a first text universal feature associated with the continual learning language model;
perform a first universal feature classification processing with the first text universal feature being input into a universal feature classifier, to obtain the first test result, the universal feature classifier being obtained by training an initial classifier based on sample probe task data and a universal feature classification label corresponding to the sample probe task data when parameters of the continual learning language model are fixed;
perform a second text universal feature extraction processing with the universal test text data being input into the initial pre-trained language model, to obtain a second text universal feature associated with the initial pre-trained language model; and
perform a second universal feature classification processing with the second text universal feature being input into the universal feature classifier, to obtain the second test result.

10. The apparatus according to claim 9, wherein
the probe task set comprises a syntactic task set and a semantic task set, and the universal test text data comprises syntactic test text data in the syntactic task set and semantic test text data in the semantic task set;
the first text universal feature comprises a first syntactic feature and a first semantic feature; and the universal feature classifier comprises a syntactic classifier and a semantic classifier; and
the processing circuitry is configured to:
perform a first syntactic classification task processing with the first syntactic feature being input into the syntactic classifier, to obtain a first syntactic classification result;
perform a first semantic classification task processing with the first semantic feature being input into the semantic classifier, to obtain a first semantic classification result; and
use the first syntactic classification result and the first semantic classification result as the first test result.

11. The apparatus according to claim 10, wherein
the second text universal feature comprises a second syntactic feature and a second semantic feature; and
the processing circuitry is configured to:
perform a second syntactic classification task processing with the second syntactic feature being input into the syntactic classifier, to obtain a second syntactic classification result;
perform a second semantic classification task processing with the second semantic feature being input into the semantic classifier, to obtain a second semantic classification result; and
use the second syntactic classification result and the second semantic classification result as the second test result.

12. The apparatus according to claim 9, wherein the processing circuitry is configured to:
obtain the continual learning language model when the initial pre-trained language model continually learns the one or more classification tasks till the completion of the first classification task;
perform a text universal feature extraction processing with the sample probe task data being input into the continual learning language model, to obtain a sample universal feature;
perform a universal feature classification processing with the sample universal feature being processed by the initial classifier, to obtain a sample universal feature classification result;
determine loss information according to the sample universal feature classification result and the universal feature classification label corresponding to the sample probe task data; and
perform parameter adjustment on the initial classifier based on the loss information until a training iteration condition is satisfied, to obtain the universal feature classifier.

13. The apparatus according to claim 8, wherein the processing circuitry is configured to:
determine a first universal detection result associated with the first classification task according to the classification accuracy difference between the first classification accuracy and the second classification accuracy;
determine a second universal detection result associated with the first classification task according to the test result difference between the first test result and the second test result; and
perform statistical calculations on first universal detection results respectively associated with the one or more classification tasks and second universal detection results respectively associated with the one or more classification tasks, to obtain the final universal detection result.

14. The apparatus according to claim 13, wherein the processing circuitry is configured to:
use a difference value between the first test result and the second test result as a universal difference; and
determine a ratio of the universal difference to the second test result as the second universal detection result.

15. A non-transitory computer-readable storage medium storing instructions which when executed by at least one processor cause the at least one processor to perform:
performing respective classification task test processing on a continual learning language model and a single-task language model by using a first task set associated with a first classification task, to obtain a first classification accuracy of the continual learning language model and a second classification accuracy of the single-task language model, the continual learning language model being obtained after an initial pre-trained language model continually learns one or more classification tasks until a completion of the first classification task, the single-task language model being obtained after the initial pre-trained language model learns the first classification task alone;
performing a first test processing on a first text universal representation of the continual learning language model by using a probe task set, to obtain a first test result associated with the continual learning language model;
performing a second test processing on a second text universal representation of the initial pre-trained language model by using the probe task set, to obtain a second test result associated with the initial pre-trained language model; and
determining a final universal detection result according to a classification accuracy difference between the first classification accuracy and the second classification accuracy, and a test result difference between the first test result and the second test result, the final universal detection result indicating an association relationship between a universal representation capability of the continual learning language model and a universal representation capability of a non-continual learning model, the non-continual learning model comprising the initial pre-trained language model and the single-task language model.

16. The non-transitory computer-readable storage medium according to claim 15, wherein the instructions cause the at least one processor to perform:
performing a first text universal feature extraction processing with universal test text data in the probe task set being input into the continual learning language model, to obtain a first text universal feature associated with the continual learning language model;
performing a first universal feature classification processing with the first text universal feature being input into a universal feature classifier, to obtain the first test result, the universal feature classifier being obtained by training an initial classifier based on sample probe task data and a universal feature classification label corresponding to the sample probe task data when parameters of the continual learning language model are fixed;
performing a second text universal feature extraction processing with the universal test text data being input into the initial pre-trained language model, to obtain a second text universal feature associated with the initial pre-trained language model; and
performing a second universal feature classification processing with the second text universal feature being input into the universal feature classifier, to obtain the second test result.

17. The non-transitory computer-readable storage medium according to claim 16, wherein the probe task set comprises a syntactic task set and a semantic task set, and the universal test text data comprises syntactic test text data in the syntactic task set and semantic test text data in the semantic task set; the first text universal feature comprises a first syntactic feature and a first semantic feature; and the universal feature classifier comprises a syntactic classifier and a semantic classifier; and
the instructions cause the at least one processor to perform:
a first syntactic classification task processing with the first syntactic feature being input into the syntactic classifier, to obtain a first syntactic classification result;
a first semantic classification task processing with the first semantic feature being input into the semantic classifier, to obtain a first semantic classification result; and
using the first syntactic classification result and the first semantic classification result as the first test result.

18. The non-transitory computer-readable storage medium according to claim 17, wherein the second text universal feature comprises a second syntactic feature and a second semantic feature; and the instructions cause the at least one processor to perform:
a second syntactic classification task processing with the second syntactic feature being input into the syntactic classifier, to obtain a second syntactic classification result;
a second semantic classification task processing with the second semantic feature being input into the semantic classifier, to obtain a second semantic classification result; and
using the second syntactic classification result and the second semantic classification result as the second test result.

19. The non-transitory computer-readable storage medium according to claim 16, the instructions cause the at least one processor to perform:
obtaining the continual learning language model when the initial pre-trained language model continually learns the one or more classification tasks till the completion of the first classification task;
a text universal feature extraction processing with the sample probe task data being input into the continual learning language model, to obtain a sample universal feature;
a universal feature classification processing with the sample universal feature being processed by the initial classifier, to obtain a sample universal feature classification result;
determining loss information according to the sample universal feature classification result and the universal feature classification label corresponding to the sample probe task data; and
parameter adjustment on the initial classifier based on the loss information until a training iteration condition is satisfied, to obtain the universal feature classifier.

20. The non-transitory computer-readable storage medium according to claim 15, wherein the instructions cause the at least one processor to perform:
determining a first universal detection result associated with the first classification task according to the classification accuracy difference between the first classification accuracy and the second classification accuracy;
determining a second universal detection result associated with the first classification task according to the test result difference between the first test result and the second test result; and
statistical calculations on first universal detection results respectively associated with the one or more classification tasks and second universal detection results respectively associated with the one or more classification tasks, to obtain the final universal detection result.
